(19) United States
(12) Patent Application Publication
(10) Pub. No.: US 2010/0096445 A1
(43) Pub. Date: Apr. 22, 2010

(54) AUTOMATIC MATCHING AND RECORDING SYSTEM

(75) Inventors: Shey-Shi LU, Taipei (TW); Kai-Wen YEH, Taipei (TW); Yi-chin LEE, Taipei (TW); Yao-Hung WANG, Taipei (TW); Hung-Wei CHIU, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: National Taiwan University, Taipei City (TW)

(21) Appl. No.: 12/471,620

(22) Filed: May 26, 2009

(30) Foreign Application Priority Data
Oct. 16, 2008 (TW) 097139797

(51) Int. Cl. G06F 17/00

(52) U.S. Cl. 235/375

(57) ABSTRACT

An automatic matching and recording system in accordance with the present invention senses and identifies a unique entity, determines when an entity is within a maximum activation range, collects measured data, transmits and stores parametric data sensed by measurement apparatuses, can be used in medical, production, fabrication and assembly monitoring and assessment and comprises at least one data module and multiple communication modules. The data module stores identification and parametric data about a particular entity. The communication modules comprise a data transaction device, a portable activation and transmission device and at least one portable activation device sensor

### FIELD OF THE INVENTION

The present invention relates to an automatic matching and recording system, especially to an automatic matching and recording system capable of identifying a particular entity and recording sensed parameters relevant to that entity.

### DESCRIPTION OF THE RELATED ART

Recently, RFID cards and different types of sensing cards have been developed for uses such as transit-cards for public transportation, cash-cards, RFID keys and the like. However, all of the foregoing applications require near-field {i.e. virtual contact} communication between a transceiver (i.e. a reader) and a transponder (i.e. RFID and sensing cards). Therefore, the transponder (i.e. the RFID or sensing card) must pass in close proximity to (i.e. in virtual contact with) the transceiver (i.e. a card reader or the like) before the transceiver and transponder can communicate.

Electronic measurement apparatuses such as biomedical and quality control instruments have replaced many conventional mechanical measurement apparatuses in hospitals for physical examinations and medical monitoring and factories and repair facilities to support calibration and quality control. For example, electronic sphygmomanometers have replaced mercury sphygmomanometers. Operation of the electronic sphygmomanometer is so easy that patients can take measurements on their own without a nurse's help, and the measured result is presented clearly and quickly. The electronic sphygmomanometer is convenient and significantly reduces workload of nurses and trained medical personnel.

A physical examination is a process by which a health care provider investigates a patient's body for signs of disease or injury. Each electronic biomedical measurement apparatus generates an individual measured parameter; and a nurse or nurses needs to collect all the parameters and enter the data into a database for further analysis by medical personnel. When combined with a patient's medical history, measurements taken during a physical examination aid in making a correct diagnosis so a treatment plan can be documented in a database in the hospital. This further reduces nurses' and medical personnel's workload since they usually have to write the data into a patient's medical record.

However, time required for nurses to collect and enter the parameters into the database depends on how many different parameters have been taken. This becomes especially burdensome when physical examinations are being performed on large groups such as physical examinations for military inductees.

Moreover, entering the parameters is subject to clerical and typographical errors. Such errors can result in incorrect diagnosis, incorrect treatment or both.

Furthermore, manufacturing, fabrication and assembly processes must keep track of parts and quality control to maintain yield and control cost. Many automated production, fabrication and assembly lines require manual intervention when defects are identified by automated monitoring equipment.

Detailed production, fabrication and assembly histories are seldom generated because too many workers would be required and would greatly reduce the productivity and yield if current workers maintained and updated the histories.

If such histories could be economically generated and maintained, manufacturers, fabricators and assemblers would have a tool that could significantly improve production yield and reduce cost associated with scraped products and rework.

Accordingly, how to make the sensing system more convenient to use is a relevant issue for related industries to pursue.

### SUMMARY OF THE INVENTION

The objective of an automatic matching and recording system in accordance with the present invention is to automatically sense and identify an entity and automatically sense and record a parameter for the particular entity sensed.

An automatic matching and recording system in accordance with the present invention senses and identifies a unique entity, determines when an entity is within a maximum activation range, collects measured data, transmits and stores parametric data sensed by measurement apparatuses, can be used in medical, production, fabrication and assembly monitoring and assessment and comprises at least one data module and multiple communication modules.

The data module stores identification and parametric data about a particular entity.

The communication modules comprise a data transaction device, a portable activation and transmission device and at least one portable activation device sensor.

### BRIEF DESCRIPTION OF THE DRAWINGS

FIG. 1 is an operational perspective view of an automatic matching and recording system in accordance with the present invention in use with a conventional biomedical measurement apparatus;

FIG. 2 is a block diagram of an embodiment of an identification transaction device of the automatic matching and recording system in FIG. 1;

FIG. 3 is a block diagram of an embodiment of a portable activation and transmission device of the automatic matching and recording system in FIG. 1;

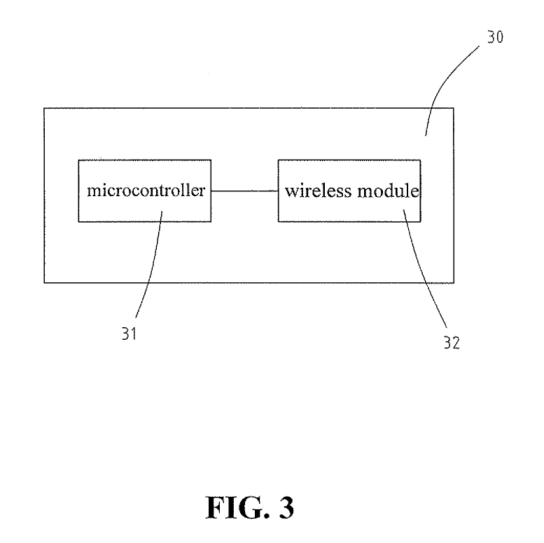

FIG. 4 is a block diagram of an embodiment a portable activation device sensor of the automatic matching and recording system in FIG. 1;

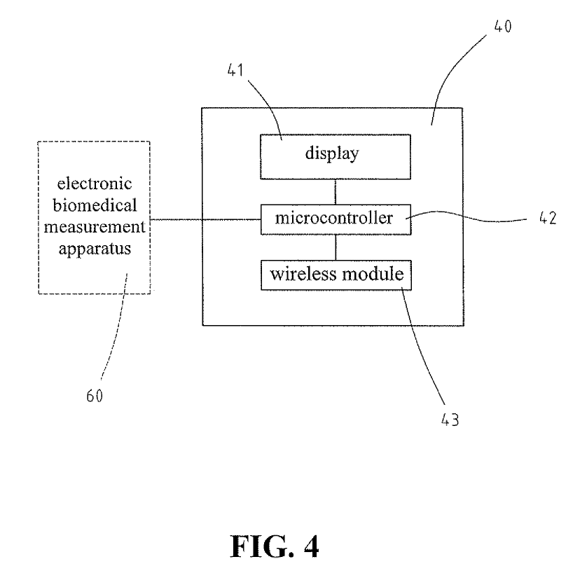

FIG. 5 is a block diagram of an embodiment of a control station of the automatic matching and recording system in FIG. 1.

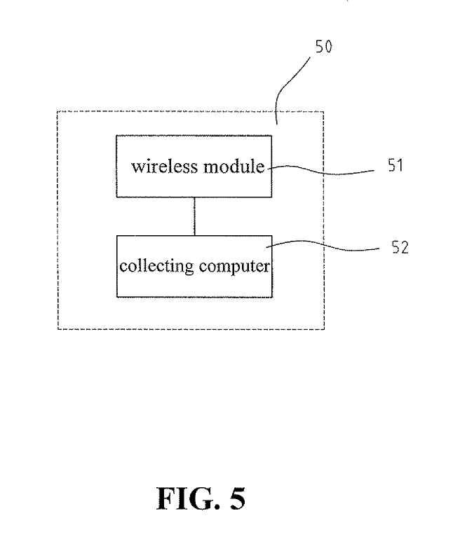

### DETAILED DESCRIPTION OF THE PRESENT INVENTION

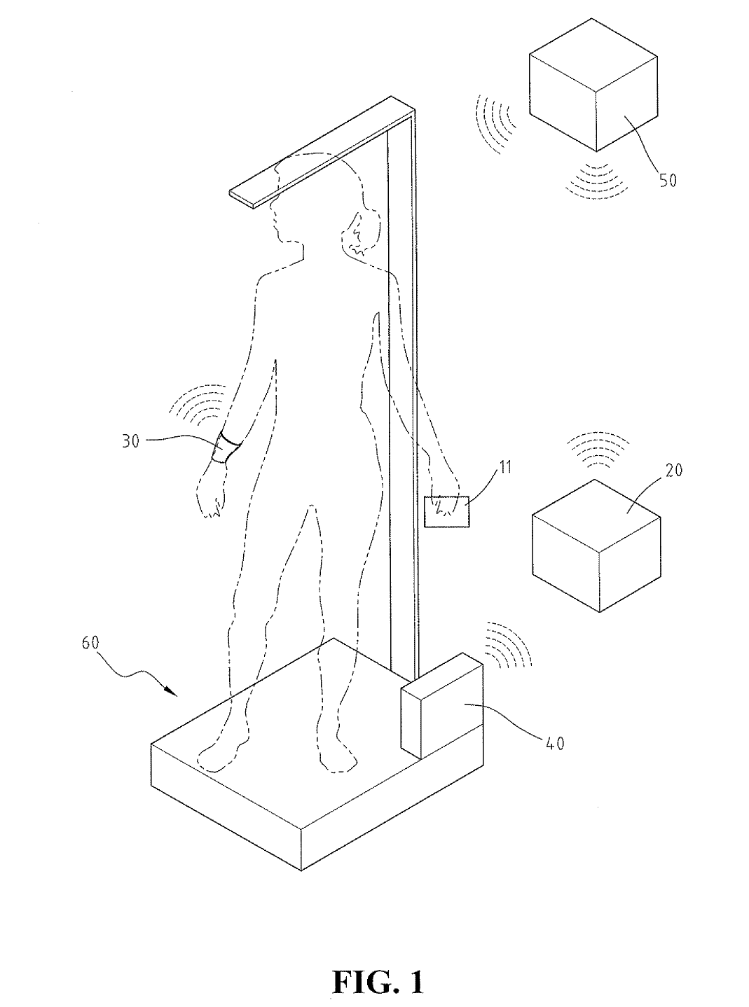

With reference to FIG. 1, an automatic matching and recording system in accordance with the present invention senses and identifies a unique entity, determines when an entity is within a maximum activation range, collects measured data, transmits and stores parametric data sensed by new and conventional measurement apparatuses (60), can be used in medical production, fabrication and assembly monitoring and assessment and comprises at least one data module (11) and multiple communication modules.

The at least one data module (11) is a transponder, stores identification and sensed parametric data about a particular entity, maintains a parametric database, may be a radio-frequency identification (RFID) card that stores identification data and stores and maintains the parametric database based on data sensed by new or conventional measurement apparatuses (60) and may be mounted on a piece of equipment or carried by a patient.

The identification data may be selected from a group comprising a patient's name, age, personal identification number, medical history and previous biomedical data, a device identification number, part numbers, test results and the like.

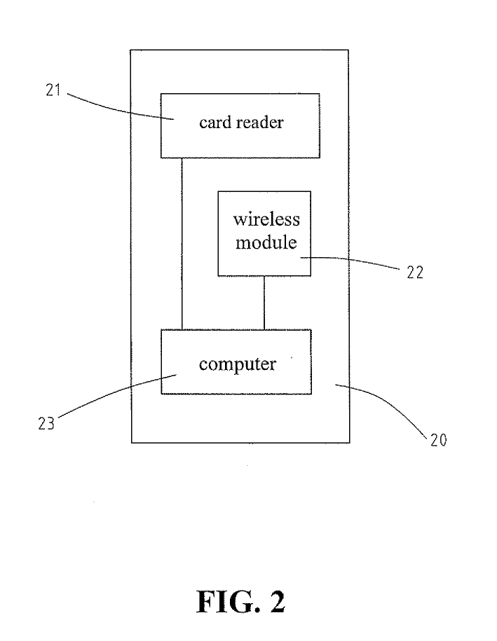

With further reference to FIGS. 2˜5, the communication modules are transceivers, respectively have wireless modules (22, 32, 43, 51) and comprise a data transaction device (20), a portable activation and transmission device (30), at least one portable activation device sensor (40) and an optional control station (50).

The data transaction device (20) communicates with the data module (11), senses identification and sensed parametric data on the data module (11), updates the parametric database, senses when the entity is in position to be tested, transmits activation signals, transmits measured parameters via email or short message service (SMS) and comprises a card reader (21), a computer (23), a wireless module (22) and an optional network card.

The card reader (21) corresponds to the data module (11), senses the data on the data module (11) and updates data on the data module (11).

The computer (23) is connected to the card reader (21), stores multiple entities' information and updates an entity's information with information from the card reader (21).

The wireless module (22) is connected to the computer (23) and transmits the entity's information received from the card reader (21).

The network card connects to a network and may be an Ethernet network card.

The portable activation and transmission device (30) senses and identifies an entity, communicates with corresponding communication modules, determines an RSSI value to indicate an entity's proximity to a particular measurement apparatus (60) and comprises a microcontroller (31) and a wireless module (32).

The microcontroller (31) determines the RSSI value and may be an MSP430 series microcontroller.

The wireless module (32) is connected to and controlled by the microcontroller, transmits a device number uniquely assigned to corresponding communication modules and senses information about the entity from the data module (11).

The at least one portable activation device sensor (40) is mounted on each electronic measurement apparatus (60), determines when the portable activation and transmission device (30) is in close proximity to the portable activation device sensor (40), receives the entity's identification information and the device number from the portable activation and transmission device (30), transmits measured parameters received and comprises a wireless module (43), a reset button, a display (41), a microcontroller (42) and an optional network card.

The wireless module (43) receives the entity's identification information from the identification transaction device (20), the device number from the portable activation and transmission device (30) and a control signal from the portable activation device and transmits the measured parameters.

The display (41) displays the entity's identity.

The reset button terminates measurement of the electronic measurement apparatus (60) when pressed.

The microcontroller (42) controls the display (41), may be a MSP430 series microcontroller, is connected to the electronic measurement apparatus on which the portable activation device sensor (40) is mounted, senses received signal strength indication (RSSI) of a signal from the wireless module (32) of the portable activation and transmission device (30) and determines which portable activation and transmission device (30) is closest to the electronic measurement apparatus (60) based on the largest RSSI, and an entity with an RSSI of the portable activation and transmission device (30) greater than 210 indicates that the entity is close enough to the measurement apparatus for the entity's parameters to be measured.

The network card connects to a network, communicates with the identification transaction device (20) through the network and may be an Ethernet network card. The control station (50) receives measured parameters from the portable activation device sensors (40), stores the measured parameters, sorts the measured parameters in an appropriate format such as a medical record, transmits the measured parameters to the identification transaction device (20) and comprises a wireless module (51), a computer (52) and an optional network card.

The wireless module (51) receives measured parameters from the portable activation device sensors (40) and transmits the measured parameters to the identification transaction device (20).

The computer (52) is connected to the wireless module (51), receives measured parameters from the wireless module (51), sorts the measured parameters in an appropriate format such as a medical format (i.e. the measured biomedical parameters from the biomedical sensing devices (40) may be binary that may not be readable), stores the measured parameters and directs the wireless module (51) to transmit all the measured parameters to the identification transaction device (20).

The network card connects to a network, communicates with the portable activation device sensor (40) and the identification transaction device (20) through the network and may be an Ethernet network card.

What is claimed is:

1. An automatic matching and recording system for identifying a unique entity, collecting data, transmitting and storing parametric data comprising
at least one transponder identification about an entity and maintains a parametric database; and
multiple communication modules being transceivers, respectively having wireless modules sensing and identifying an entity, communicating with corresponding communication modules, determining an entity's proximity to a particular measurement apparatus.

2. The automatic matching and recording system as claimed in claim 1, wherein the communication modules comprising
a data transaction device communicating with the data module, sensing identification and sensed parametric data on the data module, updating the parametric database, sensing when the entity is in position to be tested, transmitting activation signals, transmitting measured parameters;
a portable activation and transmission device sensing and identifying an entity, communicating with corresponding communication modules, determining an entity's proximity to a particular measurement apparatus; and
at least one portable activation device sensor being mounted on each electronic measurement apparatus, determining when the portable activation and transmission device is in close proximity to the portable activation device sensor, receiving the entity's identification information and the device number from the portable activation and transmission device, transmitting measured parameters received.

3. The automatic matching and recording system as claimed in claim 2, wherein the data transaction device comprising
a card reader corresponding to the data module, sensing the data on the data module and updating data on the data module;
a computer being connected to the card reader, storing multiple entities' information and updating the entity's information with information from the card reader; and
a wireless module being connected to the computer and transmitting the entity's information received from the card reader.

4. The automatic matching and recording system as claimed in claim 3, wherein the portable activation and transmission device comprising
a microcontroller that determines the RSSI value; and
a wireless module being connected to and controlled by the microcontroller, transmitting a device number uniquely assigned to corresponding communication modules and sensing information about the entity from the data module.

5. The automatic matching and recording system as claimed in claim 4, wherein the portable activation device sensor comprising
a wireless module receiving the entity's identification information from the identification transaction device, the device number from the portable activation and transmission device and a control signal from the portable activation device and transmits the measured parameters;
a display being connected to the wireless module and displaying an entity's identity;
a reset button terminates measurement of the electronic measurement apparatus when pressed; and
a microcontroller controlling the display, being connected to the electronic measurement apparatus on which the portable activation device sensor is mounted, sensing RSSI of a signal from the wireless module of the portable activation and transmission device and determining which portable activation and transmission device is closest to the electronic measurement apparatus based on the largest RSSI, and an entity with an RSSI of the portable activation and transmission device greater than 210 indicates that the entity is close enough to the measurement apparatus for the entity's parameters to be measured.

6. The automatic matching and recording system as claimed in claim 5, wherein the data module is a radio-frequency identification (RFID) card that stores identification data and stores and maintains a parametric database based on data sensed by measurement apparatuses.

7. The automatic matching and recording system as claimed in claim 5, wherein the data module is mounted on a piece of equipment.

8. The automatic matching and recording system as claimed in claim 5, wherein the data module is carried by a patient.

9. The automatic matching and recording system as claimed in claim 5, wherein the microcontroller in each portable activation and transmission device and portable activation device sensor is an MSP430 series microcontroller; and
the data transaction device further comprises a network card being connected to a network;
the portable activation device sensor further comprises a network card being connected to a network and communicating with the identification transaction device through the network.

10. The automatic matching and recording system as claimed in claim 5, wherein the identification data being selected from a group comprising a patient's name, age, personal identification number, medical history and previous biomedical data, a device identification number, part numbers and test results.

11. The automatic matching and recording system as claimed in claim 5, wherein the data transaction device transmits measured parameters via email.

12. The automatic matching and recording system as claimed in claim 5, wherein the data transaction device transmits measured parameters via short message service (SMS).

13. The automatic matching and recording system as claimed in claim 5 further comprises a control station that receives measured parameters from the portable activation device sensors, stores the measured parameters, sorts the measured parameters in an appropriate format, transmits the measured parameters to the identification transaction device and comprises
a wireless module receiving measured parameters from the portable activation device sensors and transmitting the measured parameters to the identification transaction device; and
a computer being connected to the wireless module, receiving measured parameters from the wireless module, sorting the measured parameters in an appropriate format, storing the measured parameters and directing the wireless module to transmit all the measured parameters to the identification transaction device.

14. The automatic matching and recording system as claimed in claim 9, wherein the network cards are Ethernet network cards.

15. The automatic matching and recording system as claimed in claim 13, wherein the control station further comprises a network card connecting to a network and communicating with the portable activation device sensor and the identification transaction device through the network.

16. The automatic matching and recording system as claimed in claim 15, wherein the network card is an Ethernet network card.
